(19) United States
(12) Patent Application Publication
(10) Pub. No.: US 2005/0225521 A1
(43) Pub. Date: Oct. 13, 2005

(54) [LIQUID CRYSTAL ON SILICON PANEL AND DRIVING METHOD THEREOF]

(76) Inventors: Hon-Yuan Leo, Tainan County (TW); Yen-Chen Chen, Tainan County (TW); Yung-Yuan Ho, Tainan County (TW)

Correspondence Address: JIANQ CHYUN INTELLECTUAL PROPERTY OFFICE, 7 FLOOR-1, NO. 100, ROOSEVELT ROAD, SECTION 2, TAIPEI, 100, TW

(21) Appl. No.: 10/710,346

(22) Filed: Jul. 2, 2004

(30) Foreign Application Priority Data
Apr. 12, 2004 (TW) 93110067

(51) Int. Cl. G09G 3/36

(52) U.S. Cl. 345/87

(57) ABSTRACT

A liquid crystal on silicon panel and a driving method thereof are provided. The LCOS panel and the driving method thereof of the present invention will complete driving the M×K sub-pixels after scanning I times, wherein M is the horizontal resolution and I<K. Hence, it can reduce the product cost of the drivers without sacrificing the frame rate. In addition, because of the discrete design of the even column driver and odd column driver, the width for the layout of the column driver can be double.

### CROSS REFERENCE TO RELATED APPLICATIONS

This application claims the priority benefit of Taiwan application serial no. 93110067, filed on Apr. 12, 2004.

### BACKGROUND OF INVENTION

1. Field of the Invention

This invention generally relates to a liquid crystal panel, and more particularly to liquid crystal on silicon (LCOS) panel and the driving method thereof.

2. Description of Related Art

The liquid crystal display (LCD) has been widely used to replace the CRT recently. The LCD has the advantages of low power consumption, lightweight, high resolution, high color saturation, and long lifetime. Hence, the LCD has been applied as the display for the electronic products such as the laptop or desktop computer and the LCD TV. The liquid crystal panel is the key factor to the quality of the LCD.

FIG. 1 is a block diagram of a traditional thin film transistor liquid crystal panel. In FIG. 1, the source driver 110 drives a plurality of source lines 112-118 (a.k.a. data lines) for driving the pixels. The gate drive 130 drives a plurality of gate lines 132-138 (a.k.a. scan lines). The display area 120 includes a plurality of transistors 152-168 and the liquid crystal capacitors 181-197.

The operation of the liquid crystal panel is as follows: driving one gate line at a time, e.g., gate line 132, to turn on all transistors 152-156 on the gate line 132, and inputting the pixel data via the source lines 112-118 to drive the liquid crystal capacitors 181-185; driving the next gate line, e.g., the gate line 134, and inputting the pixel data via the source lines 112-118 to drive the liquid crystal capacitors 187-191. By driving the liquid crystal capacitors 181-197 in the display area 120 in sequence, the entire image can be displayed.

FIG. 2 is a block diagram of a traditional thin film transistor liquid crystal panel with 800×600 resolution. The thin film transistor liquid crystal panel includes the source driver 210, the display area 220 and the gate driver 230. The display area 220 has 800×600×3 sub-pixels to provide 800×600 resolution. I.e., each pixel includes R, G, and B sub-pixels. When the gate driver 230 drives a gate line, the source driver 210 will drive the 800×3 sub-pixels. Obviously, this driving method causes higher circuit complexity, higher power consumption and higher production cost because the source drive 210 has higher circuit complexity, higher power consumption and higher production cost than the gate drive 230.

FIG. 3 is a block diagram of another traditional thin film transistor liquid crystal panel with 800×600 resolution. The thin film transistor liquid crystal panel includes the source driver 310, the display area 320 and the gate driver 330. The display area 320 has 800×600×3 sub-pixels to provide 800×600 resolution. The display area 320 has 800×600×3 sub-pixels to provide 800×600 resolution. When the gate driver 330 drives a gate line, the source driver 310 will drive the 800 sub-pixels. Only when the gate driver 330 drives three gate lines continuously, can the pixels including R, G, and B sub-pixels on the same row of the display area 320 be driven. Although this driving method can reduce the circuit complexity, power consumption and production cost of the source driver 310, it will face the bottleneck when trying to increase the frame rate because the gate driver 330 has to process data 3 times as many as the gate driver 230 of FIG. 2 during the same scan time.

Recently, the liquid crystal display technology has been applied to the LCD projector. Because the liquid crystal panel adopted by the LCD projector has to take the image resolution into account, most LCD projectors will adopt the LCOS panel because of its high resolution.

Generally, a LCOS panel is a liquid crystal device on the silicon substrate. The LCOS panel uses the MOS transistors as the active devices. These active devices can drive the liquid crystal via the reflective electrode coupled to the active devices to display the image. Because the LCOS panel is on the silicon substrate, it has a compact size and provides high resolution, which meet the compact-size requirement for the LCD projectors. However, the structure and the driving method thereof should be improved.

### SUMMARY OF INVENTION

The present invention is directed to a LCOS panel and a driving method thereof to reduce the product cost of the drivers without sacrificing the frame rate. In addition, because of the discrete design of the even column driver and odd column driver, the width for the layout of the column driver can be double.

The present invention is directed to a liquid crystal panel, comprising: a display area having M×N (e.g., 800×600) pixels for providing M×N resolution, each of the pixels including K sub-pixels (e.g., R, G, and B sub-pixels); a row driver having I×N scan lines coupled to the display area (e.g., I=2); and a column driver having J×M data lines coupled to the display area (e.g., J=1.5) for cooperating with the row driver to complete driving M pixels on a same row in the display area after the row driver scans I times, wherein I×J=K, and 1<I, J<K.

In an embodiment of the present invention, the column driver includes: an even column driver for driving an even portion of the J×M data lines in the display area (e.g., when j=1.5 and M=800, 800×1.5/2=600 data lines can be driven); and an odd column driver for driving an odd portion of the J×M data lines in the display area (e.g., the other 600 data lines can be driven). After the row driver scans twice, the 800 pixels on a same row in the display area will be driven; i.e., 800×3=2400 sub-pixels are driven.

The present invention is directed to a method for driving a liquid crystal panel having a display area having M×N (e.g., 800×600) pixels for providing M×N resolution, each of the pixels including K sub-pixels (e.g., R, G, and B sub-pixels), the method comprising: scanning I×N scan lines (e.g., I=2) in the display area in sequence; and providing J×M sub-pixel data (e.g., J=1.5) to the J×M data lines in the display area after scanning each of the I×N scan lines to complete driving M pixels on a same row in the display area after scanning the scan lines for I times; wherein I×J=K, and 1<I, J<K.

In light of the above, because the LCOS panel and the driving method thereof, according to an embodiment of the present invention, will complete driving the M×K sub-pixels after scanning I times (I<K), it can reduce the cost on the drivers without sacrificing the frame rate. In addition, because of the discrete design of the even column driver and odd column driver, the width for the layout of the column driver can be double.

The above is a brief description of some deficiencies in the prior art and advantages of the present invention. Other features, advantages and embodiments of the invention will be apparent to those skilled in the art from the following description, accompanying drawings and appended claims.

### BRIEF DESCRIPTION OF DRAWINGS

FIG. 1 is the block diagram of a traditional thin film transistor liquid crystal panel.

FIG. 2 is a block diagram of a traditional thin film transistor liquid crystal panel with 800×600 resolution.

FIG. 3 is a block diagram of another traditional thin film transistor liquid crystal panel with 800×600 resolution.

FIG. 4 is a block diagram of a LCOS panel with 800×600 resolution in accordance with an embodiment of the present invention.

FIG. 5 shows the arrangement of the sub-pixels of a LCOS panel with 800×600 resolution in accordance with an embodiment of the present invention.

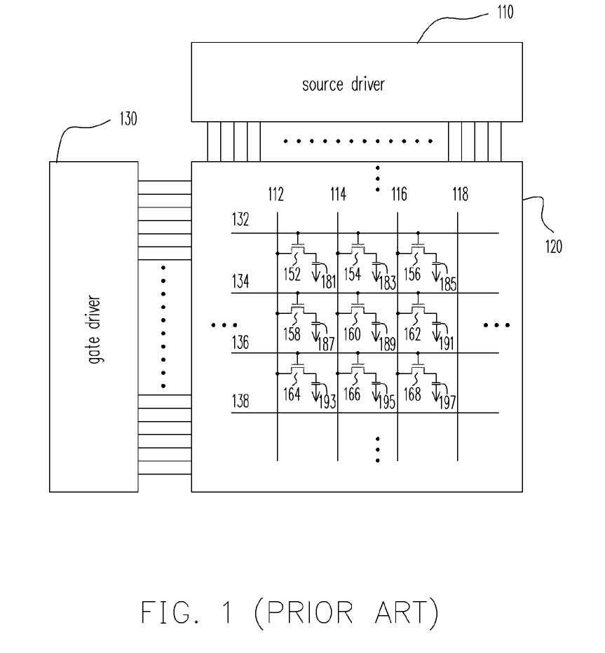

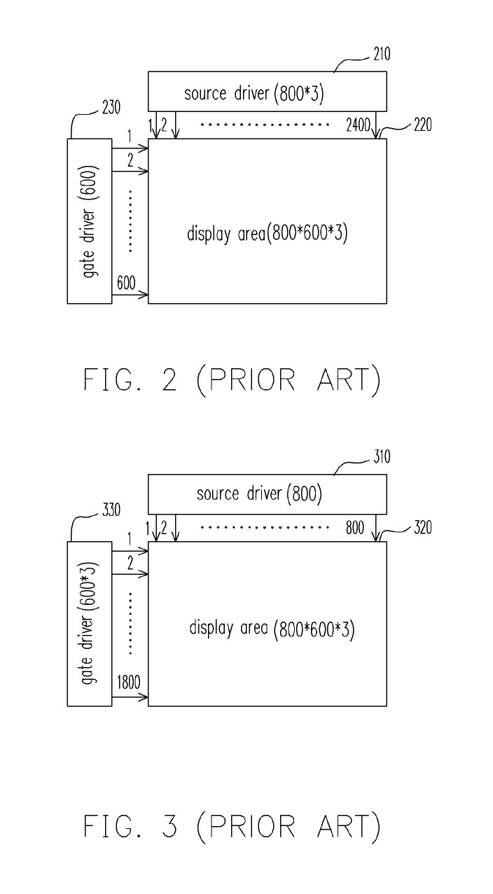

### DETAILED DESCRIPTION

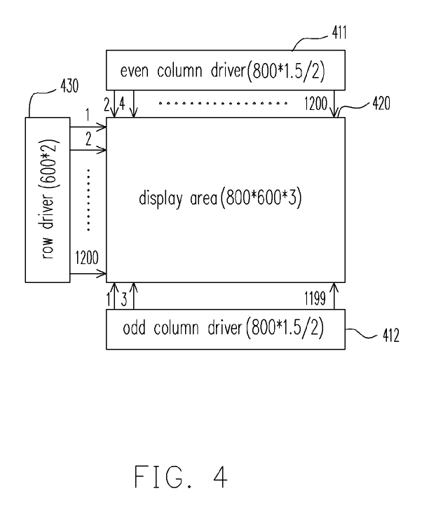

FIG. 4 is a block diagram of a LCOS panel with 800×600 resolution in accordance with an embodiment of the present invention. As shown in FIG. 4, the LCOS panel includes the display area 420, the row driver 430, and the column driver including the even column driver 411 and the odd column driver 412. The row driver 430 controls the on/off of the pixel transistors via the scan lines coupled to the gates of the pixel transistors (not shown) in the display area 420. The even column driver 411 and the odd column driver 412 send the pixel data to the pixel electrodes (not shown) via the data lines coupled to the sources of the pixel transistors (not shown) in the display area 420. The reason to divide the column driver into the even column driver 411 and the odd column driver 412 is to double the layout width of the column driver. Another alternative design is to combine the even column driver 411 and the odd column driver 412 into a single column driver.

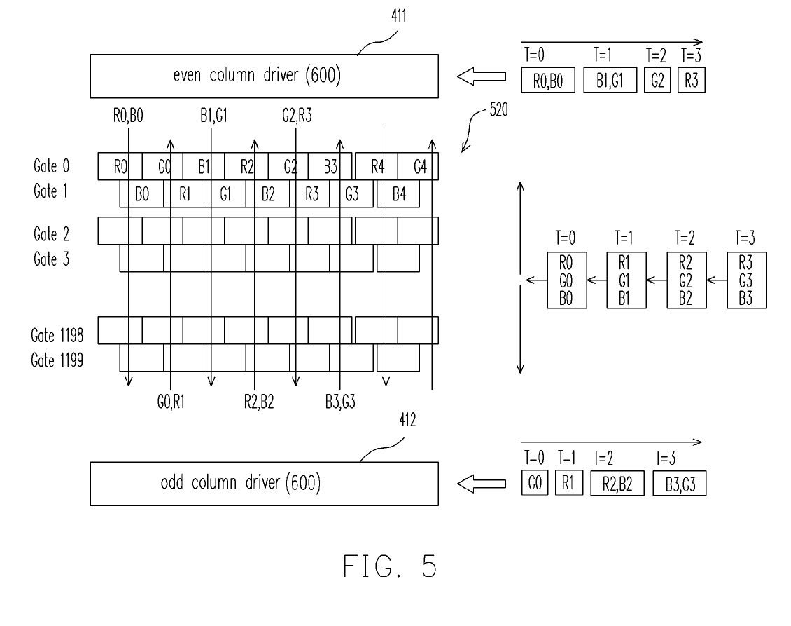

As shown in FIG. 4, the display area 420 includes 800×600 pixels for providing 800×600 resolution. Each of the pixels includes R, G, and B sub-pixels. The arrangement for different color sub-pixels is for example shown in the display area 520 of FIG. 5. The arrangement shown in FIG. 5 is used to illustrate the sequence of the data transmission and should not be used to limit the scope of the present invention.

The row driver 430 has 2×600 scan lines coupled to the display area 420. Each of the even column driver 411 and the odd column driver 412 has 800×1.5/2=600 data lines coupled to the display area 420. I.e., the 800 pixels in each row of the display area 420 include the data of 800×3=2400 sub-pixels. Hence, after the row driver 430 scans twice, the 800 pixels on a same row in the display area will be driven; i.e., 800×3=2400 sub-pixels are driven.

Referring to FIG. 5, the right side of FIG. 5 is the sequence of the pixel data transmitted via the data bus. R0, G0 and B0 respectively represent the pixel data to drive the sub-pixel R0, G0, and B0; R1, G1 and B1 respectively represent the pixel data to drive the sub-pixel R1, G1 and B1; R2, G2 and B2 respectively represent the pixel data to drive the sub-pixel R2, G2 and B2, etc. When T=0, the data bus receives the pixel data of R0, G0, and B0. At the time, the pixel data of R0 and B0 will be sent to the even column driver 411 and the pixel data of G0 will be sent to the odd column driver 412 based on the arrangement of the sub-pixels. When T=1, the data bus receives the pixel data of R1, G1, and B1. At the time, the pixel data of B1 and G1 will be sent to the even column driver 411 and the pixel data of R1 will be sent to the odd column driver 412 based on the arrangement of the sub-pixels. When T=2, the data bus receives the pixel data of R2, G2 and B2. At the time, the pixel data of R2 and B2 will be sent to the odd column driver 411 and the pixel data of G2 will be sent to the even column driver 412 based on the arrangement of the sub-pixels.

Referring to FIGS. 4 and 5, when the row driver 430 of FIG. 4 drives the scan line Gate0, the even column driver 411 would respectively drive the pixel data of R0, B1, G2, etc. to the data lines coupled to the sub-pixels R0, B1, G2, etc.; the odd column driver 412 would respectively drive the pixel data of G0, R2, B3, etc. to the data lines coupled to the sub-pixels G0, R2, B3, etc. When the row driver 430 of FIG. 4 drives the scan line Gate1, the even column driver 411 would respectively drive the pixel data of B0, G1, R3, etc. to the data lines coupled to the sub-pixels B0, G1, R3, etc.; the odd column driver 412 would respectively drive the pixel data of R1, B2, G3, etc. to the data lines coupled to the sub-pixels R1, B2, G3, etc. Hence, after the row driver 430 scans the scan lines Gate0 and Gate1, it completes driving the 800 pixels (which includes 2400 sub-pixels such as R0, G0, B0, R1, G1, B1) on a same row in the display area 520.

Therefore, the method for driving the LCOS panel is as follows: scanning I×N scan lines (e.g., I=2) in the display area in sequence; and providing J×M sub-pixel data (e.g., J=1.5) to the J×M data lines in the display area after scanning each of the I×N scan lines to complete driving M pixels on a same row in the display area after scanning the scan lines for I times; wherein I×J=K, and 1<I, J<K.

It should be noted that the row driver 430 can be divided into even and odd row drivers disposed at the two sides of the display area 420 respectively (not shown). In addition, the method for driving row is not limited to be from the top to the bottom. It can be from the bottom to the top. Likewise, the method for driving column is not limited to be from the left to the right. It can be from the right to the left.

In addition, because the present invention is applied to the liquid crystal panel, the pixels can be, but not limited to, arranged in a delta manner as shown in FIG. 5. The pixels can also be arranged in a stripe line or a mosaic line manner.

Further, the driving timing sequence is generated by the timing sequence control circuit. Hence, the driving method of the present invention can be applied to a timing sequence control circuit.

In light of the above, the present invention has the following advantages:

1. Because the LCOS panel and the driving method thereof of the present invention will complete driving the M×K sub-pixels after scanning I times (I<K), it can reduce the product cost of the drivers without sacrificing the frame rate.

2. Because of the discrete design of the even column driver and odd column driver, the width for the layout of the column driver can be double.

The above description provides a full and complete description of the preferred embodiments of the present invention. Various modifications, alternate construction, and equivalent may be made by those skilled in the art without changing the scope or spirit of the invention. Accordingly, the above description and illustrations should not be construed as limiting the scope of the invention which is defined by the following claims.

1. A liquid crystal panel, comprising:
a display area having M×N pixels for providing M×N resolution, each of said pixels including K sub-pixels;
a row driver having I×N scan lines coupled to said display area; and
a column driver having J×M data lines coupled to said display area for cooperating with said row driver to complete driving M pixels on a same row in said display area after said row driver scans I times, wherein I×J=K, and 1<I, J<K.

2. The liquid crystal panel of claim 1, wherein said K is 3, said I is 2, and said J is 1.5.

3. The liquid crystal panel of claim 1, wherein said column driver includes:
an even column driver for driving an even portion of said J×M data lines in said display area; and
an odd column driver for driving an odd portion of said J×M data lines in said display area.

4. The liquid crystal panel of claim 1, wherein said row driver includes:
an even row driver for driving an even portion of said I×N scan lines in said display area; and
an odd row driver for driving an odd portion of said I×N scan lines in said display area.

5. The liquid crystal panel of claim 1, wherein said M×N pixels are arranged in one of a delta manner, a stripe line manner, and a mosaic line manner.

6. A liquid crystal display projector system, said liquid crystal display projector system comprising said liquid crystal panel of claim 1.

7. A method for driving a liquid crystal panel having a display area having M×N pixels for providing M×N resolution, each of said pixels including K sub-pixels, said method comprising:
scanning I×N scan lines in said display area in sequence; and
providing J×M sub-pixel data to J×M data lines in said display area after scanning each of said I×N scan lines to complete driving M pixels on a same row in said display area after scanning said scan lines for I times;
wherein I×J=K, and 1<I, J<K.

8. The method of claim 7, wherein said K is 3, said I is 2, and said J is 1.5.

9. The method of claim 7, wherein said step of scanning said I×N scan lines comprises scanning said I×N scan lines in sequence from top to bottom.

10. The method of claim 7, wherein said step of scanning said I×N scan lines comprises scanning said I×N scan lines in sequence from bottom to top.

11. The method of claim 7, wherein said step of providing said J×M sub-pixel data to said J×M data lines comprises providing said J×M sub-pixel data to said J×M data lines from left to right.

12. The method of claim 7, wherein said step of providing said J×M sub-pixel data to said J×M data lines comprises providing said J×M sub-pixel data to said J×M data lines from right to left.

13. A timing sequence driving method for a timing sequence control circuit, said timing sequence driving method at least comprising said method for driving said liquid crystal panel of claim 7.
